(19) United States
(12) Patent Application Publication
(10) Pub. No.: US 2023/0136468 A1
(43) Pub. Date: May 4, 2023

(54) COLLECTIBLE WITH THEMED DESIGN AND CONTENT

(71) Applicant: Tesseract Ventures, LLC, Overland Park, KS (US)

(72) Inventor: John BOUCARD, Overland Park, KS (US)

(73) Assignee: Tesseract Ventures, LLC, Overland Park, KS (US)

(21) Appl. No.: 17/915,397

(22) PCT Filed: Mar. 31, 2021
(86) PCT No.: PCT/US2021/025168

§ 371 Date: Sep. 28, 2022

Related U.S. Application Data
(60) Provisional application No. 63/002,798, filed on Mar. 31, 2020.

(51) Int. Cl. H04N 5/64; G08C 17/02; H04N 21/422

(52) U.S. Cl. CPC H04N 5/64; G08C 17/02; H04N 21/42203

(57) ABSTRACT

A collectible is provided. The collectible includes a viewer operable to display content. The viewer has a body which at least partially encapsulates a processor and a display. The body forms a recess which is operable to at least partially receive a remote. The remote is operable to control the viewer. When the remote is at least partially received within the viewer, the remote and the viewer together form a design which corresponds to a theme. The content displayed by the viewer also corresponds to the theme. The display has a size that is smaller than 2 inches.

### CROSS-REFERENCE TO RELATED APPLICATION

This application claims priority to U.S. Provisional Pat. Application No. 63/002,798, filed in the U.S. Pat. and Trademark Office on Mar. 31, 2020, all of which is incorporated herein by reference in its entirety for all purposes.

### FIELD

The present disclosure relates generally to collectibles. In at least one example, the present disclosure relates to a collectible which can be used in a diorama, the collectible including a viewer and a remote with a design corresponding to a theme, where the viewer displays content corresponding to the theme.

### BACKGROUND

Collectibles are desired by consumers because the collectibles provide a unique and interesting experience. Additionally, the consumer may be motivated to acquire the entire series or collection of the collectibles.

Television systems can display visual and audio content. The content can be recordings accessed through storage media such as VHS tapes, hard disk drives, DVDs, flash drives, Blue-ray discs, and/or online. The content can also be transmitted through radio-frequency receivers, coaxial cables, optical fiber, satellite systems, and/or the internet. The content can be, for example shows, songs, and/or images. Throughout the years, many shows became household favorites.

Televisions screens are measured diagonally, from corner to corner. The television systems are conventionally large devices with screen sizes ranging from 19 inches to 85 inches, with some screens being even larger than 85 inches. As display technology improves, the trend for newly developed screens are to be larger and provide a clearer image.

Additionally, the designs of the television systems evolved over time. Many consumers may fondly relate designs of television systems or objects such as furniture or toys with certain content from that time period.

A collectible with a tiny display which is designed and displays content corresponding to a theme such as a time period provides a unique experience which has not previously existed. Accordingly, the collectible fills a need for the consumer to acquire the collectible or collection of collectibles and any corresponding accessories.

### BRIEF DESCRIPTION OF THE DRAWINGS

Implementations of the present technology will now be described, by way of example only, with reference to the attached figures.

FIG. 1A is a diagram illustrating an example of a collectible in accordance with the present disclosure.

FIG. 1B is a diagram illustrating a front-perspective, partially exploded view of the collectible of FIG. 1A.

FIG. 1C is a diagram illustrating a rear-perspective, partially exploded view of the collectible of FIG. 1A.

FIG. 1D is a diagram illustrating a front-perspective, exploded view of the collectible of FIG. 1A.

FIG. 1E is a diagram illustrating an example environment of a diorama which can include a collectible.

FIG. 2 is a diagram illustrating a processor in accordance with the present disclosure.

FIG. 3A is a diagram illustrating a collectible interacting with a physical trigger.

FIG. 3B is a diagram illustrating a collectible with connector components to interact with a physical trigger.

FIG. 4 is a diagram illustrating a collectible with a digital trigger interacting with an external device.

FIG. 5 is a diagram illustrating a collectible with an audible trigger emitting from an external device.

### DETAILED DESCRIPTION

It will be appreciated that for simplicity and clarity of illustration, where appropriate, reference numerals have been repeated among the different figures to indicate corresponding or analogous elements. Features discussed in relation to a figure may be utilized in combination with features discussed in other figures. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Disclosed herein is a collectible which includes a viewer and a remote operable to control the viewer. The design of the collectible corresponds to a theme, such as a television set from the 1960s, 1970, etc. The viewer is operable to at least partially receive the remote such that the viewer and the remote together form the design of the collectible. The collectible is operable to display content such as videos, images, and/or audio which corresponds to the theme. For example, the collectible may have a design of a 1960s television set, and the content may include shows, clips, bloopers, trailers, behind the scenes, images, games, and/or songs which were popular during the 1960s. Additionally, the collectible has a very small size. For example, the display of the viewer may be less than 2 inches. All together, the design, the content, and the size of the collectible create a product which is very enticing to consumers.

To further excite the consumers, additional content may be unlocked when certain conditions are met. Different triggers and/or actions may unlock the additional content and/or a next step in unlocking the additional content. The triggers may include interactions with the collectible such as a certain combination of buttons or scrolling through a certain number of pieces of content. The triggers may also include a physical trigger such as an accessory corresponding to the theme which interacts with the collectible, for example through radio-frequency identification (RFID), resistors, and/or EEPROM. The triggers may also include a digital trigger such as a QR code which can be scanned by an external device to unlock the additional content either on the collectible or on the external device. The triggers may also include an audible trigger. The audible trigger can include an audible signal emitted by an external device such as a phone, a television set, and/or an additional collectible. The audible signal can include a hypersonic tone which includes a signal to be demodulated by the collectible. The signal from the hypersonic tone then instructs the collectible to unlock the additional content and/or a next step in unlocking the additional content.

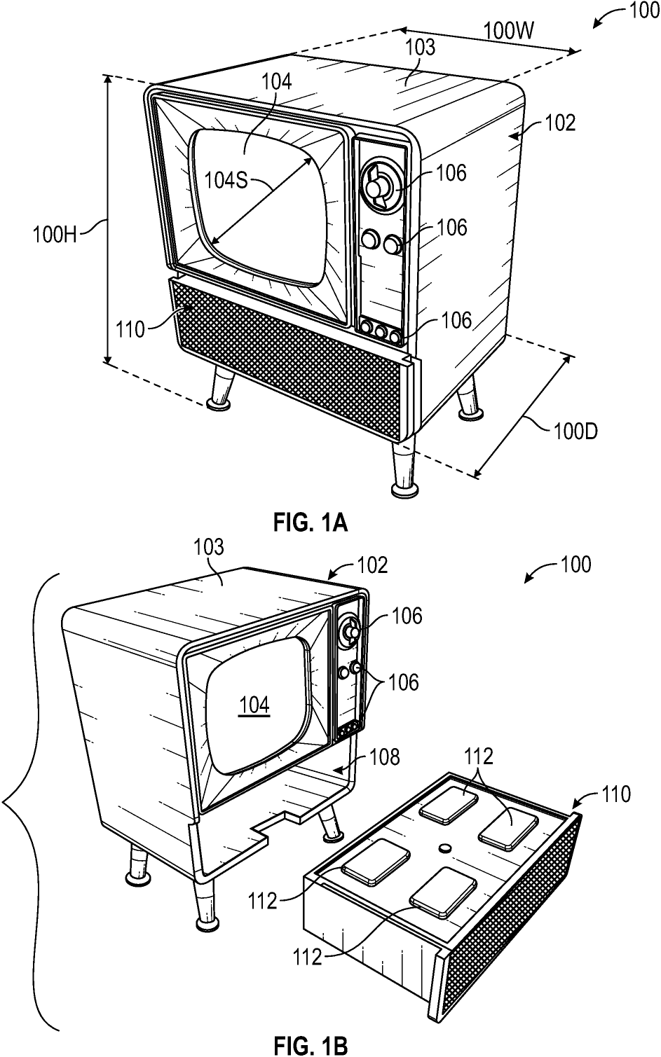

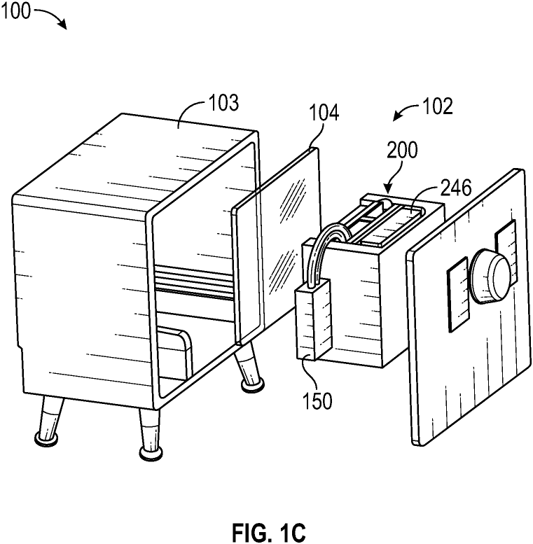

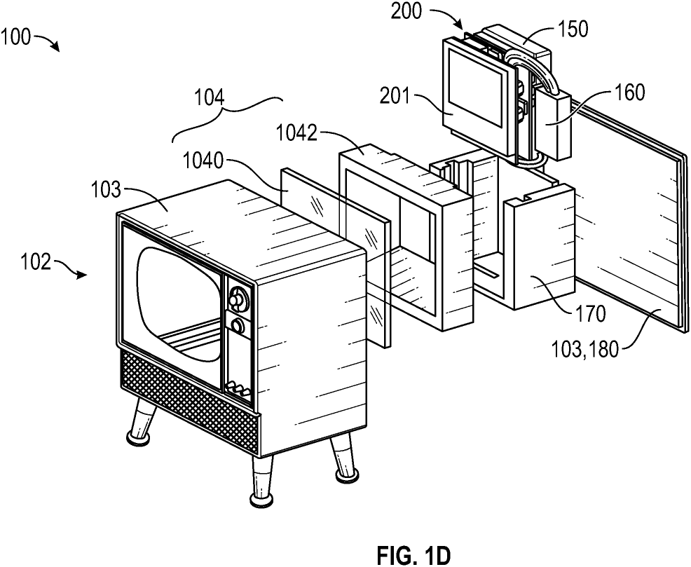

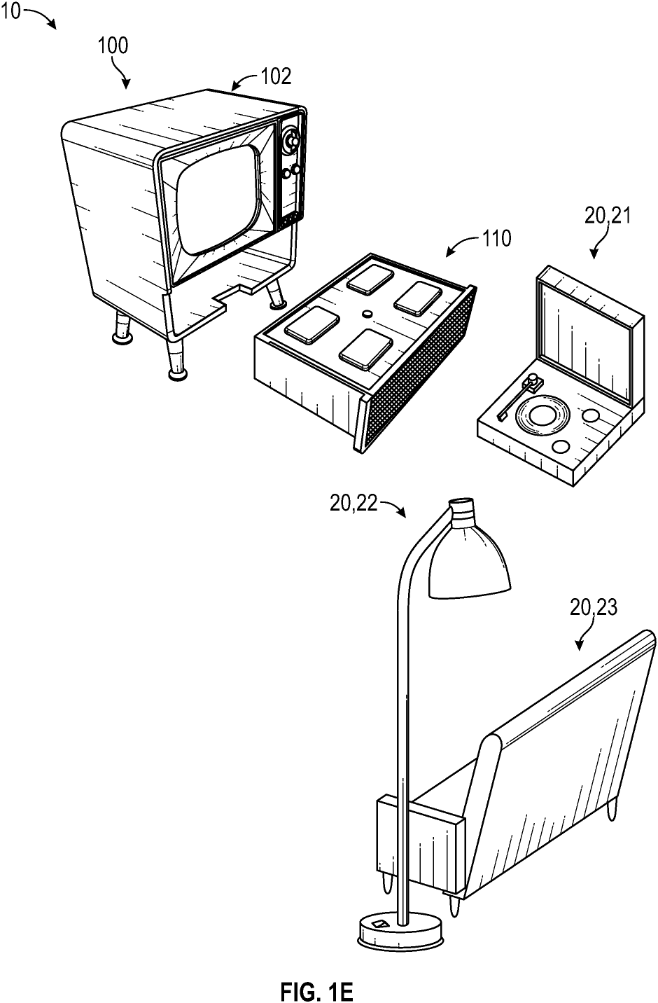

The disclosure now turns to FIGS. 1A-1D, which illustrate a diagrammatic view of an exemplary collectible 100. The collectible 100 includes a viewer 102 and a remote 110 operable to control the viewer 102. As illustrated in FIGS. 1A-1D, the viewer 102 includes a body 103 which at least partially encapsulates a display 104, a processor 200, a power component 150 which is operable to provide power to the collectible 100, and/or a speaker 160 which is operable to emit audio from the viewer 102. As shown in FIG. 1D, a rear panel 180 may enclose the display 104, processor 200, power component 150, and/or speaker 160 in the body 103 of the viewer 102. In some examples, as illustrated in FIG. 1D, the collectible 100 can include a main processor 200 and a display processor 201. The main processor 200 may control functions such as the audio, content, and/or interaction with triggers 300 as discussed below. The display processor 201 may control the display 104. In other examples, the collectible 100 may only include the main processor 200 which can control all functions of the collectible 100. In yet other examples, the collectible 100 may include more processors to control different functions within the collectible 100. Also, in some examples as shown in FIG. 1D, the viewer 102 may include an electronics carrier 170 which may at least partially encapsulate electronic components such as the processors 200, 201 and/or the speaker 160. In some examples, as illustrated in FIGS. 1A and 1B, the body 103 of the viewer 102 includes buttons 106 which may adjust the shows, content, channels, volume, power, and/or any other controls for the viewer 102.

The viewer 102 has very small dimensions, which increases the collectability and uniqueness of the collectible 100. For example, a conventional television set may have a display size which starts at about 19 inches and can exceed 85 inches in size. The display 104 of the viewer 102 can have a size 104S measured diagonally from corner to corner of the display 104. The size 104S of the display 104 can be, for example, less than 2 inches. In some examples, the size 104S of the display 104 can be about 1.77 inches. Accordingly, the display 104 of the viewer 102 is smaller than 10% of a conventional-sized television set. A consumer would not consider watching content on such a small display 104, but the small display 104 provides a distinctly unique experience and increases the desirability of the collectible 100. Similarly, the collectible 100 may have a small size. For example, the height 100H may be less than 4 inches. In some examples, the height 100H may be less than 3.5 inches. In some examples, the height may be 3 inches or smaller. The width 100W may be less than 4.5 inches, alternatively less than 4 inches, alternatively less than 3.5 inches, or alternatively less than 3 inches. The depth 100D may be less than 2 inches.

In at least one example, as shown in FIG. 1D, the display 104 can include a lens 1040 and a shadow box 1042. The lens 1040 can be a transparent or at least partially transparent material. For example, the lens 1040 can be made of glass, a transparent plastic, or any other suitable material. In some examples, the lens 1040 may be tinted at least one color. In some examples, the lens 1040 may be clear. The shadow box 1042 can assist in directing the light for the display 104.

In at least one example, the power component 150 may be a battery, which can be a rechargeable battery and/or an alkaline or removable battery. In at least one example, the power component 150 can include a plug or a conduit which can be plugged into a power outlet (not shown). The power component 150 can provide power to the viewer 102. In some examples, the power component 150 can provide power to the remote 110, whether through a male and female connection or wirelessly transmitting power. In some examples, the remote 110 may be powered by a battery.

As shown in FIGS. 1A and 1B, the remote 110 may be configured to seamlessly incorporate with the design of the collectible 100. For example as illustrated in FIGS. 1A and 1B, the remote 110 may be configured to be inserted and at least partially received within a recess 108 within the viewer 102. The viewer 102 and the remote 110 when coupled together form the collectible 100. The remote 110 may communicate with the viewer 102 wirelessly, for example by infrared or radiofrequency signals. The remote 110 may control the viewer 102 by one or more buttons 112 on the remote 110. The buttons 112 may correspond to and adjust the shows, content, channels, volume, power, joystick game buttons, and/or any other controls for the viewer 102.

The collectible 100 may have a design which corresponds to a theme. The theme may be, for example, decade, product line, television show, movie, band, company, and/or any other desirable theme. For example, the collectible 100 illustrated in FIGS. 1A-1D has a retro design correlating with television sets in the 1960s. Other collectibles 100 in the product series may have, for example, designs correlating with television sets in the 1970s, 1980s, 1990s, and/or 2000s. The theme creates desirability of the collectible to consumers.

The viewer 102 is operable to display content in the form of videos, images, games, and/or audio. For example, the viewer 102 can display content such as television shows, clips from television shows, behind the scenes videos, and/or bloopers from television shows. In at least one example, as illustrated in FIGS. 1C and 1D, the content may be stored within the viewer 102. For example, the content may be stored in memory storage 246 such as a flash memory or cartridge/removable memory. In some examples, the content may be downloaded and/or streamed from an external source, for example the Internet. In such a case, the collectible 100 may include a wireless processor to connect wirelessly with the external source. As the display 104 has such a small size 104S, the content may need to be formatted to fit such a small display 104.

Along with the external design theme of the collectible 100, the content may also correlate with the theme. For example, the collectible 100 illustrated in FIGS. 1A-1D has the 1960s retro theme. The content displayed and/or emitted by the collectible 100 may include videos, games, images, and/or audio from television shows that were popular in the 1960s, for example Batman, Lost in Space, The Twilight Zone, I Dream of Jeannie, Gilligan’s Island, The Monkees, The Beverly Hillbillies, etc. With both design and content corresponding to a theme, the collectible 100 becomes a very desirable object for consumers as the collectible 100 may evoke fond memories or fascination of that theme.

In at least one example, as illustrated in FIG. 1E, the collectible 100 may be displayed and/or utilized within an environment 10 which enhances the theme and desirability of the collectible 100. In some examples, the environment 10 may include a diorama which represents a scene correlating with the theme. As illustrated in FIG. 1E, the environment 10 is a 1960s living room. The environment 10 can include theme components 20 which enhance the environment 10 and may be relevant to and evoke memories or fascination of the theme. For example, the environment 10 as illustrated in FIG. 1E can include a sofa 23, a record player 21, and/or a lamp 22, all designed in the 1960s style. In some examples, the theme components 20 may interact with the collectible 100 to provide different experiences and/or provide their own functions which enhance the environment 10. For example, the record player 21 may be operable to play music, audio clips, and/or recordings from the 1960s. The lamp 22 may be operable to emit light when turned on. Together, the theme components 20 and the collectible 100 entice the consumer to collect all of the pieces to fill in the environment 10.

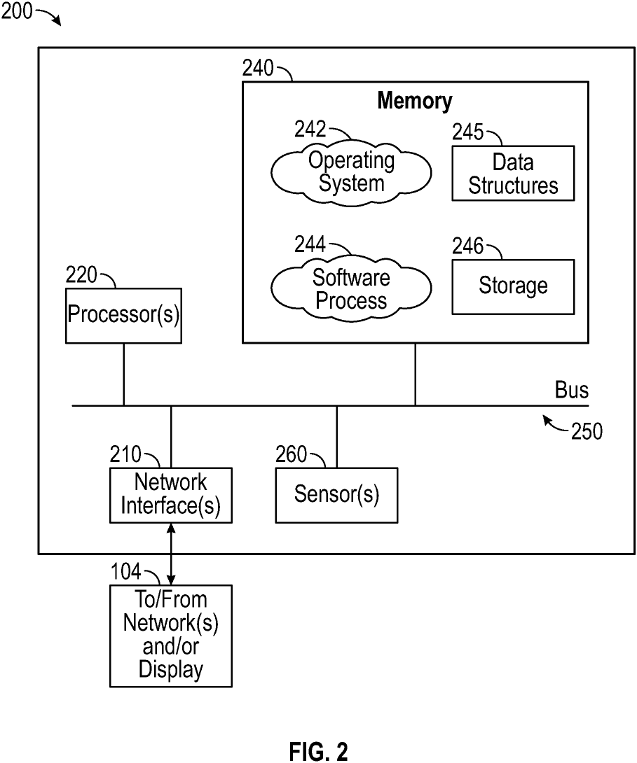

FIG. 2 is a block diagram of an exemplary processor 200, 201. Processor 200, 201 is configured to perform processing of data and communicate with the collectible, for example as illustrated in FIGS. 1A-1D. In operation, processor 200, 201 communicates with one or more of the above-discussed components and may also be configured to communication with remote devices/systems.

As shown, processor 200, 201 includes hardware and software components such as network interfaces 210, at least one processor 220, sensors 260 and a memory 240 interconnected by a system bus 250. Network interface(s) 210 can include mechanical, electrical, and signaling circuitry for communicating data over communication links, which may include wired or wireless communication links. Network interfaces 210 are configured to transmit and/or receive data using a variety of different communication protocols, as will be understood by those skilled in the art. In some examples, the network interfaces 210 may transmit data such as content to the viewer 102 such as the display 104 and/or any audio components in the viewer 102. Additionally, the network interfaces 210 may transmit and/or receive data with the remote 110.

Processor 220 represents a digital signal processor (e.g., a microprocessor, a microcontroller, or a fixed-logic processor, etc.) configured to execute instructions or logic to perform tasks in a collectible 100. Processor 220 may include a general purpose processor, special-purpose processor (where software instructions are incorporated into the processor), a state machine, application specific integrated circuit (ASIC), a programmable gate array (PGA) including a field PGA, an individual component, a distributed group of processors, and the like. Processor 220 typically operates in conjunction with shared or dedicated hardware, including but not limited to, hardware capable of executing software and hardware. For example, processor 220 may include elements or logic adapted to execute software programs and manipulate data structures 245, which may reside in memory 240. Additionally, the processor 220 may be operable to decode video and/or audio data.

Sensors 260 typically operate in conjunction with processor 220 to perform measurements, and can include special-purpose processors, detectors, transmitters, receivers, and the like.

Memory 240 comprises a plurality of storage locations that are addressable by processor 220 for storing software programs, data structures 245, and/or content in storage 246 associated with the examples described herein. An operating system 242, portions of which may be typically resident in memory 240 and executed by processor 220, functionally organizes the device by, inter alia, invoking operations in support of software processes and/or services 244 executing on processor 200. These software processes and/or services 244 may perform processing of data and communication with processor 200, as described herein. Note that while process/service 244 is shown in centralized memory 240, some examples provide for these processes/services to be operated in a distributed computing network.

It will be apparent to those skilled in the art that other processor and memory types, including various computer-readable media, may be used to store and execute program instructions pertaining to the fluidic channel evaluation techniques described herein. Also, while the description illustrates various processes, it is expressly contemplated that various processes may be embodied as modules having portions of the process/service 244 encoded thereon. In this fashion, the program modules may be encoded in one or more tangible computer readable storage media for execution, such as with fixed logic or programmable logic (e.g., software/computer instructions executed by a processor, and any processor may be a programmable processor, programmable digital logic such as field programmable gate arrays or an ASIC that comprises fixed digital logic. In general, any process logic may be embodied in processor 220 or computer readable medium encoded with instructions for execution by processor 220 that, when executed by the processor, are operable to cause the processor to perform the functions described herein.

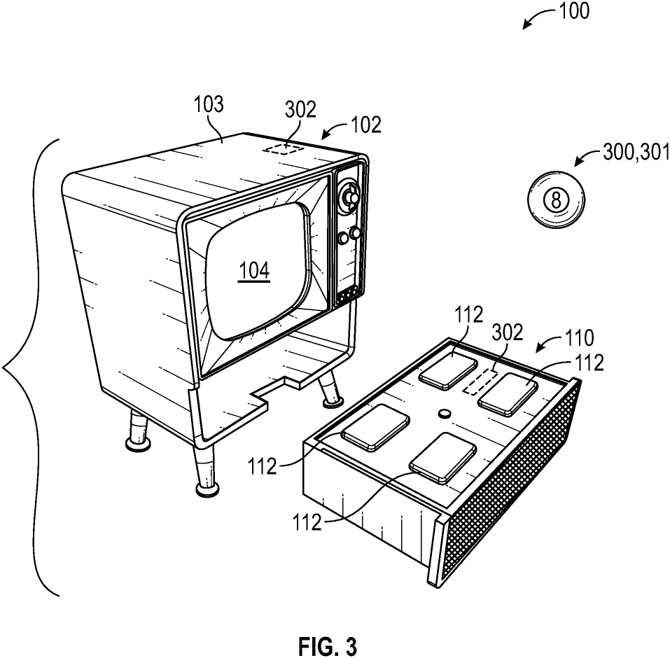

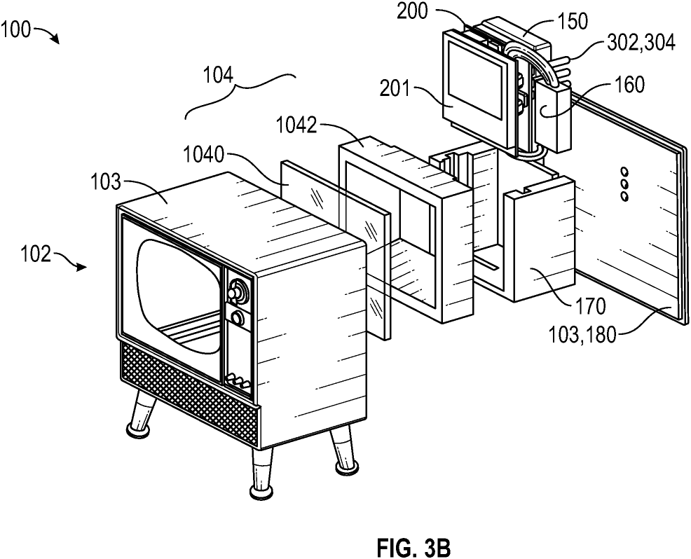

FIGS. 3-5 illustrate different ways to interact with the collectible 100 to enhance the experience. For example, by interacting with the collectible 100 in a predetermined manner, additional content may be unlocked, accessed, and enjoyed by the consumer. This enhances the user experience by sparking a desire to discover all the available content. The additional content may be unlocked by a variety and/or combination of triggers 300. In at least one example, one trigger 300 may unlock the next step needed in a combination of steps until the additional data is accessible. The one or more triggers 300 may be one of the combination of steps to unlock the additional data or the next step. For example, as will be discussed in more detail below, a physical trigger 301 may interact with the collectible 100, after which the viewer 102 may display a digital trigger 400. In some examples, only one trigger 300 may be utilized, and in some examples, multiple different triggers 300 may be required.

In at least one example, the trigger 300 may include the manner of interaction with the collectible 100. For example, additional content may be unlocked after a predetermined number of content have been accessed. The number of content required to be accessed to unlock the additional content may be randomized. In some examples, the additional content may be unlocked after a certain combination of buttons 112 of the remote 110 and/or the buttons 106 of the viewer 102 are pressed.

As illustrated in FIG. 3A, the trigger 300 may include a physical trigger 301. The physical trigger 301 such as a figurine or an accessory may interact with the remote 110 and/or the viewer 102 to unlock additional content. The physical trigger 300 as illustrated in FIG. 3A is an 8-ball, but the physical trigger 300 may be any physical accessory. For example, the physical trigger 300 may include accessories that are in line with the theme such that the physical trigger 300 may be added to a collection which includes the collectible 100, such as the theme components 20 illustrated in FIG. 1E.

The physical trigger 300 may interact with a portion 302 of the remote 110 and/or the viewer 102, for example by radio-frequency identification (RFID), a resistor, EEPROM, or any other suitable mechanism to induce the processor 200 to unlock additional content or unlock the next step in a combination of steps to provide additional content. In at least one example, the physical trigger 300 may be placed within a predetermined distance from the portion 302 of the remote 110 and/or the viewer 102. In some examples, the physical trigger 300 may need to contact the portion 302 of the remote 110 and/or the viewer 102. In some examples, as illustrated in FIG. 3B, the portion 302 of the viewer 102 which interacts with the physical trigger 300 may include one or more connecting components 304. While FIG. 3B illustrates the connecting components 304 being located on the viewer 102, in some examples, the remote 110 may include connecting components 304. The connecting components 304 may include, for example as illustrated in FIG. 3B, connector pins such that the connector pins may be inserted into a female connecting component located on the physical trigger 300. Data may be transferred upon connection between the connecting components 304 of the viewer 102 and the connecting components of the physical trigger 300. In some examples, the connecting components 304 may include male connectors corresponding to female connecting components on the physical trigger 300 as illustrated in FIG. 3B, and in some examples, the connecting components 304 may include female connectors corresponding to male connecting components on the physical trigger 300.

In some examples, the physical trigger 300 may need to itself be manipulated in a certain manner before interacting with the remote 110 and/or the viewer 102. In some examples, for example with the lamp 22 as illustrated in FIG. 1E, turning on the lamp 22 to emit light may serve as a form of interaction with the collectible 100 to unlock additional content.

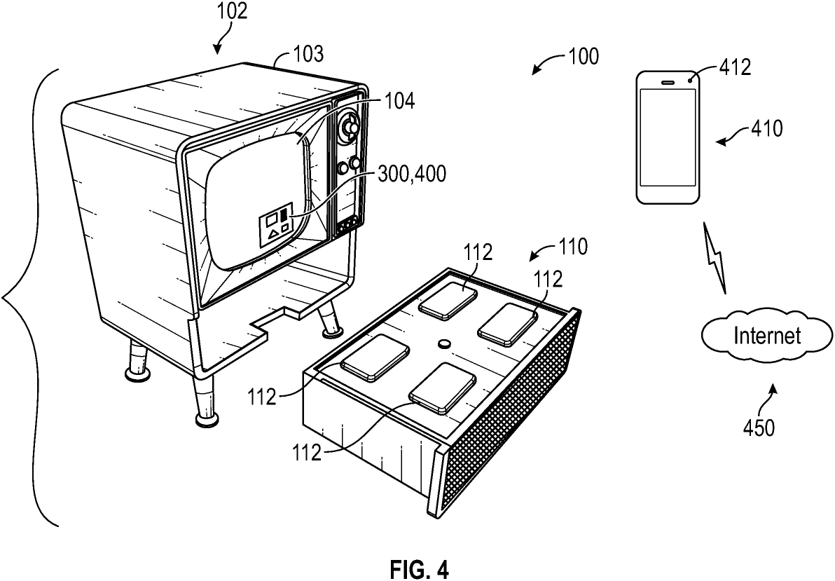

FIG. 4 illustrates a trigger 300 which includes a digital trigger 400. The digital trigger 400 can include an object displayed on the viewer 102 which may be scanned. For example, the digital trigger 400 can include a QR code or a barcode. In at least one example, the digital trigger 400 may be unlocked and shown after another trigger 300 has been activated, for example, after a physical trigger 301 interacts with the collectible 100. The digital trigger 400 can be shown on the display 104 of the viewer 102 and scanned by a camera 412 on an external device 410 such as a phone or a laptop. The external device 410 may then show the additional content and/or lead the user to the next step to unlock the additional content. The external device 410 may be connected to the Internet 450, and in some examples, the external device 410 may not require access to the Internet 450. After scanning the digital trigger 400, in some examples, the external device 410 may be directed to a website which then shows the additional content and/or leads to the next step to unlock the additional content. In some examples, an app within the external device 410 may show the additional content and/or leads to the next step to unlock the additional content.

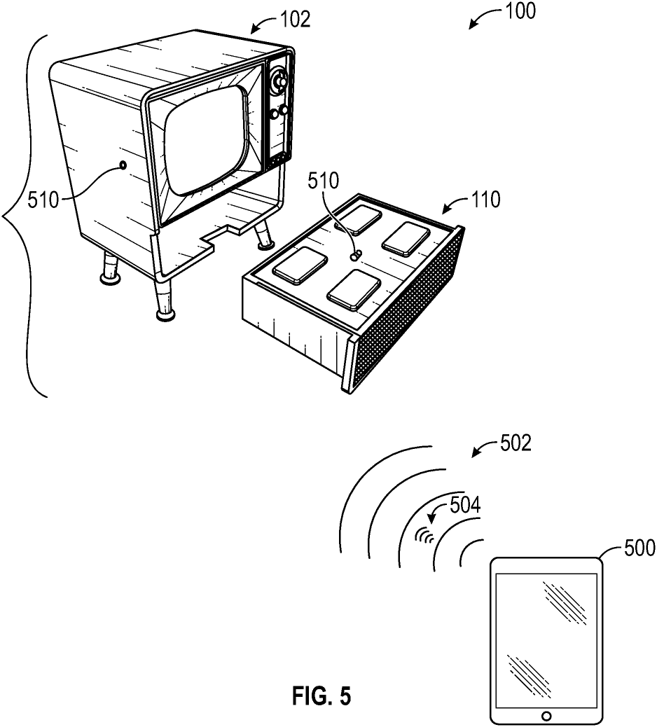

FIG. 5 illustrates a trigger 300 which may include an audible trigger 504. An external device 500 such as a phone, a laptop, a television set, a physical trigger 301, and/or another collectible 100 may emit an audible signal 502. For example, the record player 21 as illustrated in FIG. 1E may emit the audible signal 502 which can include an audible trigger 504. The remote 110 and/or the viewer 102 can include one or more microphones 510 which are operable to detect the audible signal 502. In some examples, the speaker 160 for the collectible 100 may function as a microphone 510.

The audible signal 502 can include a hypersonic tone 504 which can, for example, have a frequency of about 19 kilohertz (kHz) to about 20 kHz. The hypersonic tone 504 may not be consciously heard by a human, but is detectable by the microphone(s) 510. The processor 200 then processes the audible signal 502 and extracts the hypersonic tone 504. The hypersonic tone 504 includes a signal which is demodulated by the processor 200. When the processor 200 demodulates the signal, the viewer 102 can then show the additional content and/or lead the user to the next step to unlock the additional content.

In at least one example, the collectible 100 may interact with other collectibles 100 through the audible signal(s). The collectibles 100 may then play a message in succession and/or together display content which is only completely shown through the combination of collectibles 100. Additionally or alternatively, the collectible 100, upon processing the hypersonic tone 504 within the audible signal 502, may display a digital trigger 400 for example as discussed above in FIG. 4.

Through the different combination or options for triggers 300, the collectible 100 and the accessories associated with the collectible 100 become highly desired products for consumers to purchase and acquire. The combination of such a small sized collectible 100 with a themed design showing themed content, optionally having unlockable content, creates a fun and unique experience to the consumer and entices the consumer to collect the collectible 100 and all of the associated accessories.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. A collectible comprising:
a viewer operable to display content, the viewer having a body which at least partially encapsulates a processor and a display, the body forming a recess; and
a remote operable to control the viewer, the remote configured to at least partially be received within the recess of the body such that the remote and the viewer together form a design which corresponds to a theme,
wherein the content corresponds to the theme, and
wherein the display has a size that is smaller than 2 inches.

2. The collectible of claim 1, wherein one or more triggers unlocks additional content and/or a next step in a series of steps to unlock the additional content.

3. The collectible of claim 2, wherein the one or more triggers includes a physical trigger, wherein the physical triggers is operable to interact with the remote and/or the viewer to unlock the additional content and/or a next step in a series of steps to unlock the additional content.

4. The collectible of claim 3, wherein the physical trigger is an accessory with a design that corresponds to the theme.

5. The collectible of claim 3, wherein the physical trigger interacts with the remote and/or the viewer by a resistor, a radio-frequency identifier (RFID), and/or EEPROM.

6. The collectible of claim 2, wherein the one or more triggers includes a digital trigger which is operable to be scanned by an external device, wherein the additional data is accessible in the external device.

7. The collectible of claim 6, wherein the digital trigger includes a QR code and/or a barcode displayed on the display of the viewer.

8. The collectible of claim 2, wherein the one or more triggers includes an audible trigger which includes an audible signal operable to be detected by one or more microphones disposed on the remote and/or the viewer.

9. The collectible of claim 8, wherein the audible signal is emitted by an external device, the external device including at least one of the following: a phone, a laptop, a television set, a physical trigger and/or an additional collectible.

10. The collectible of claim 8, wherein the audible signal includes a hypersonic tone, the hypersonic tone including a signal.

11. The collectible of claim 10, wherein the processor demodulates the signal in the hypersonic tone, and the viewer, based on the signal, shows the additional content and/or leads the user to a next step to unlock the additional content.

12. A system comprising:
a collectible comprising:
a viewer operable to display content, the viewer having a body which at least partially encapsulates a processor and a display, the body forming a recess; and
a remote operable to control the viewer, the remote configured to at least partially be received within the recess of the body such that the remote and the viewer together form a design which corresponds to a theme,
wherein the content corresponds to the theme, and
wherein the display has a size that is smaller than 2 inches; and
one or more theme components, each of the theme components having a design that corresponds to the theme.

13. The system of claim 12, wherein the one or more theme components include: a sofa, a record player, and/or a lamp.

14. The system of claim 12, wherein one or more triggers unlocks additional content and/or a next step in a series of steps to unlock the additional content.

15. The system of claim 14, wherein the one or more triggers includes a physical trigger, wherein the physical triggers is operable to interact with the remote and/or the viewer to unlock the additional content and/or a next step in a series of steps to unlock the additional content.

16. The system of claim 15, wherein the physical trigger interacts with the remote and/or the viewer by a resistor, a radio-frequency identifier (RFID), and/or EEPROM.

17. The system of claim 14, wherein the one or more triggers includes a digital trigger which is operable to be scanned by an external device, wherein the additional data is accessible in the external device, wherein the digital trigger includes a QR code and/or a barcode displayed on the display of the viewer.

18. The system of claim 14, wherein the one or more triggers includes an audible trigger which includes an audible signal operable to be detected by one or more microphones disposed on the remote and/or the viewer.

19. The system of claim 18, wherein the audible signal is emitted by an external device, the external device including at least one of the following: a phone, a laptop, a television set, a physical trigger and/or an additional collectible.

20. The collectible of claim 18, wherein the audible signal includes a hypersonic tone, the hypersonic tone including a signal, wherein the processor demodulates the signal in the hypersonic tone, and the viewer, based on the signal, shows the additional content and/or leads the user to a next step to unlock the additional content.
